(19) United States
(12) Patent Application Publication
(10) Pub. No.: US 2017/0073008 A1
(43) Pub. Date: Mar. 16, 2017

(54) COLLAPSIBLE CRASH SAFETY SYSTEMS FOR THREE-WHEELED VEHICLES

(71) Applicant: Mandar Padhye, Irvine, CA (US)

(72) Inventor: Mandar Padhye, Irvine, CA (US)

(21) Appl. No.: 14/733,959

(22) Filed: Jun. 8, 2015

Related U.S. Application Data
(60) Provisional application No. 62/009,236, filed on Jun. 8, 2014.

(51) Int. Cl. B62D 21/15; B62K 25/28; B62D 23/00

(52) U.S. Cl. CPC B62D 21/15; B62D 23/005; B62K 25/283; B60Y 2200/122; B60R 21/16

(57) ABSTRACT

The present invention describes an enclosed structure to a 3 wheeler vehicle to provide crash-worthiness (i.e. protection in case of vehicular crash). The structure is further integrated into a crash protection system that absorbs and diverts the crash forces away from it's occupants thus reducing chance of injury and harm to its occupants.

### TECHNICAL FIELD

The present invention is in the technical field of automotive safety. More particularly, the present invention relates to collapsible crash safety systems in three-wheeled vehicles.

### BACKGROUND

When considering road faring vehicles as a mode of transportation the degree and quality of passenger safety are often of the most important features that are evaluated. Naturally single or dual occupancy vehicles such as motorcycles and micro-cars (e.g. Smart Cars), while appreciated for their low fuel consumption and easy maneuverability, are impractical choices due to safety concerns.

For instance during the operation of a conventional motorcycle, the driver and/or passenger is at severe risk of injury or death in case of even minor accident scenarios such as a frontal or rear crash, rollover, getting struck with an object, or getting hit by another vehicle while changing lanes on the road. This risk is primarily because the occupant is exposed out to open environment without any rigid and strong protection. Conversely micro-cars offer enclosed cabins that mitigate the effects of a crash however due to their short and four-wheeled platform they lack the maneuverability offered by motorcycles.

Thus there is current an impending need for a vehicle safety system that blends the maneuverability of a motorcycle while providing the security of an enclosed passenger compartment.

### SUMMARY OF THE INVENTION

The present invention fulfills these and other shortcomings through integrating of an enclosed structure to a 3 wheeler vehicle to provide crash-worthiness (i.e. protection in case of vehicular crash). The structure is further integrated into a crash protection system that absorbs and diverts the crash forces away from it's occupants thus reducing chance of injury and harm to its occupants.

The secondary benefit of this enclosed structure is that it will provide an all weather driving condition to its driver and/or passenger due to temperature controlled inside environment. Otherwise certain weather conditions (such as severe cold/severe heat/rain etc.) have prevented riding of a conventional motorcycle.

In some embodiments the structure can be used to house airbags to provide additional safety to occupants.

In some embodiments the structure may comprise of a metallic structure while in others a composite material may be used.

The end result is that the occupant is provided with an environment that is multiple times safer compared with a conventional motorcycle.

### BRIEF DESCRIPTION OF THE FIGURES

FIG. 1. Illustrates the forces exerted on a three-wheeled vehicle—in the event of an accident—and how said forces will be pushed away from the passenger compartment.

FIG. 2, Illustrates an exposed rear-side view of the three-wheeled vehicle in the present invention.

FIG. 3, Illustrates an exposed forward-side view of the three-wheeled vehicle in the present invention.

FIG. 4. Illustrates an exposed rear-side view of the three-wheeled vehicle, without the rear-wheels, in order to show the placement of the rear swing arms.

FIG. 5. Illustrates an exposed elevated-rear view of the three-wheeled vehicle, without the rear-wheels, in order to show the placement of the rear swing arms.

FIG. 6, Illustrates a rear-side view of the passenger compartment structure in the present invention.

FIG. 7, Illustrates a forward-side view of the passenger compartment structure in the present invention.

FIG. 8. Depicts a three-wheeled transportation vehicle that may have a passenger compartment.

FIG. 9. Illustrates a top view of the rear swing arms.

FIG. 10. Illustrates a side view of the rear swing arms.

FIG. 11. Illustrates a bottom view of how the rear swing arms may be connected to the three-wheeled vehicle.

### DETAILED DESCRIPTION OF THE INVENTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

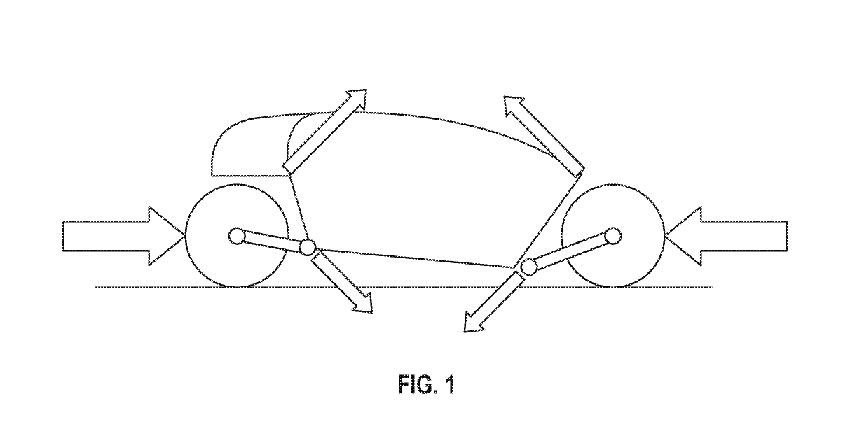

FIG. 1. Depicts a three-wheeled transportation vehicle that may have a passenger compartment.

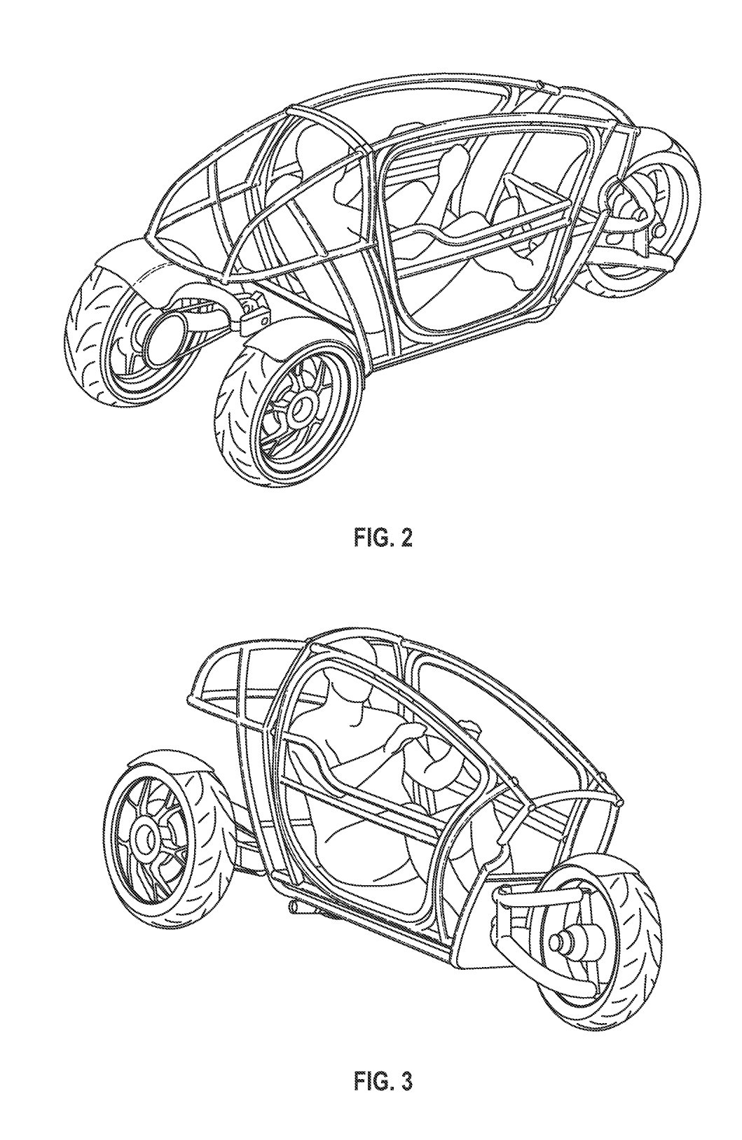

FIG. 2. Illustrates the forces exerted on a three-wheeled vehicle—in the event of an accident—and how said forces will be pushed away from the passenger compartment. The angels may vary, so long it is sufficient to collapse wheels. Further research may be done on developing ranges of angles that optimum. The angle is generally based on the friction point.

In the event of an accident wheels are pushed in and down and occupant gets pushed up like “ejection.”

FIG. 3A, Illustrates an exposed rear-side view of the three-wheeled vehicle in the present invention. FIG. 3B, Illustrates an exposed forward-side view of the three-wheeled vehicle in the present invention.

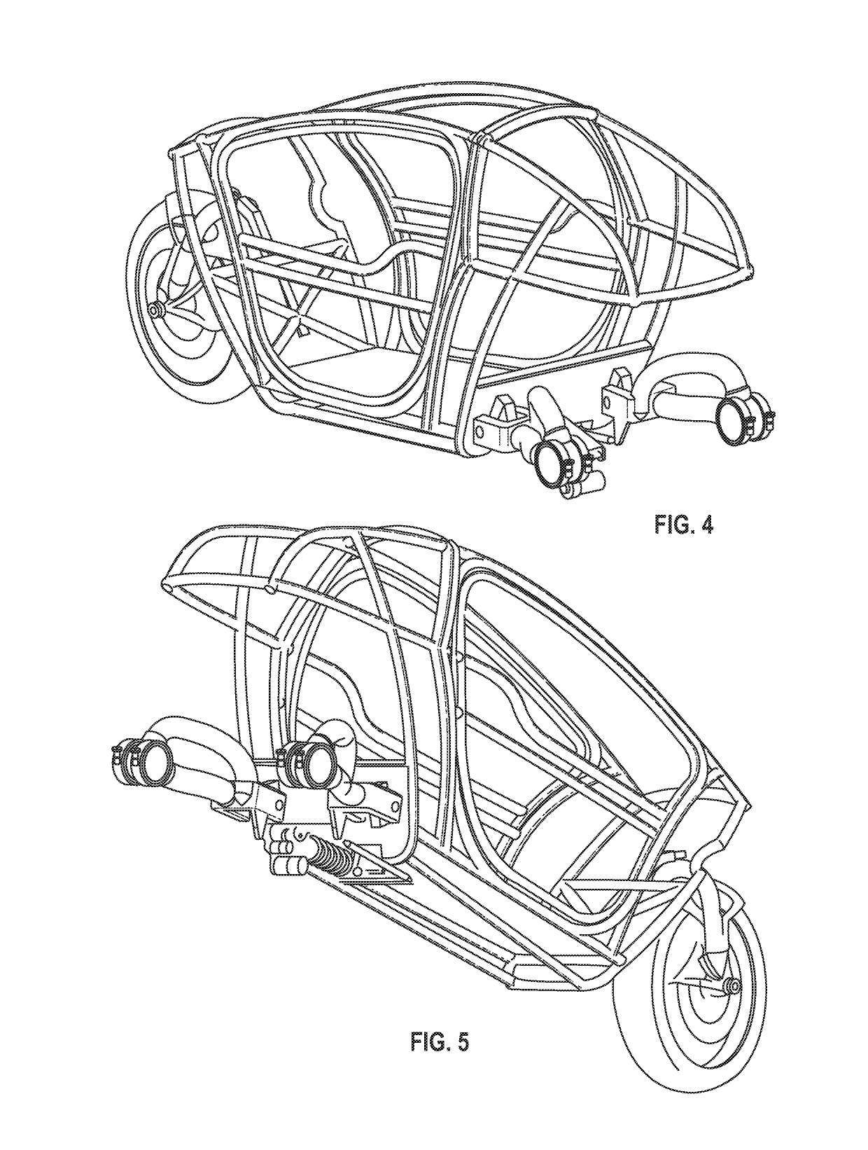

FIG. 4A. Illustrates an exposed rear-side view of the three-wheeled vehicle, without the rear-wheels, in order to show the placement of the rear swing arms. FIG. 4B. Illustrates an exposed elevated-rear view of the three-wheeled vehicle, without the rear-wheels, in order to show the placement of the rear swing arms.

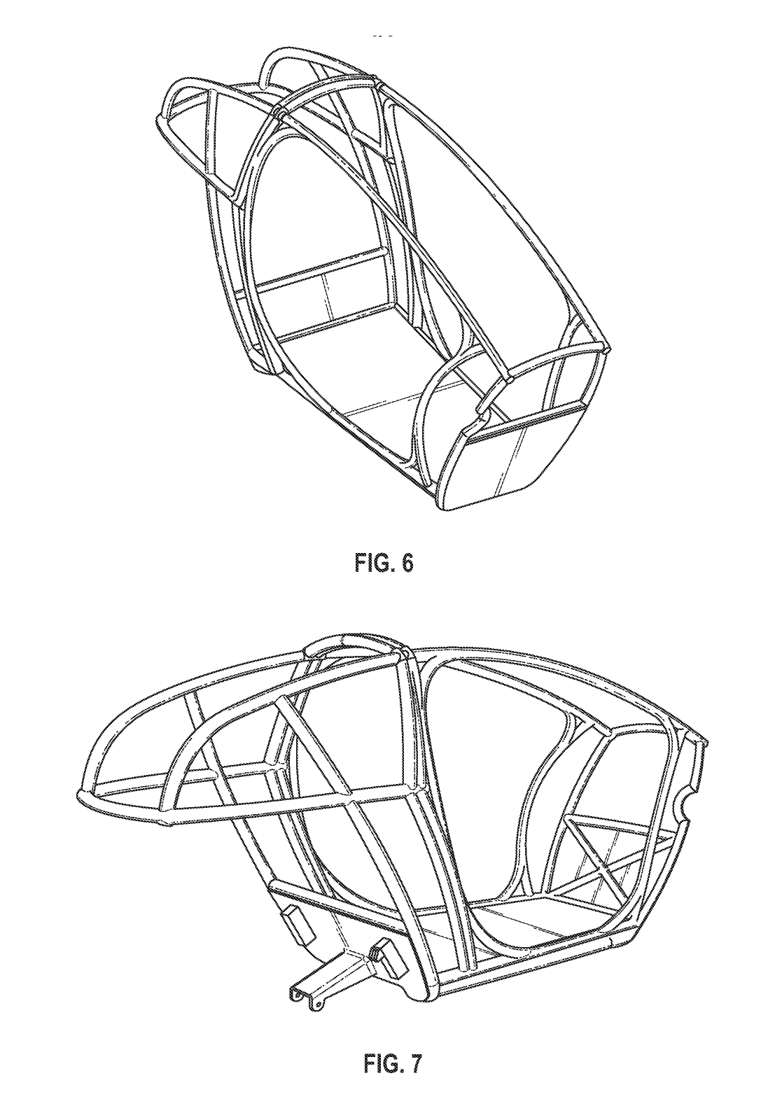

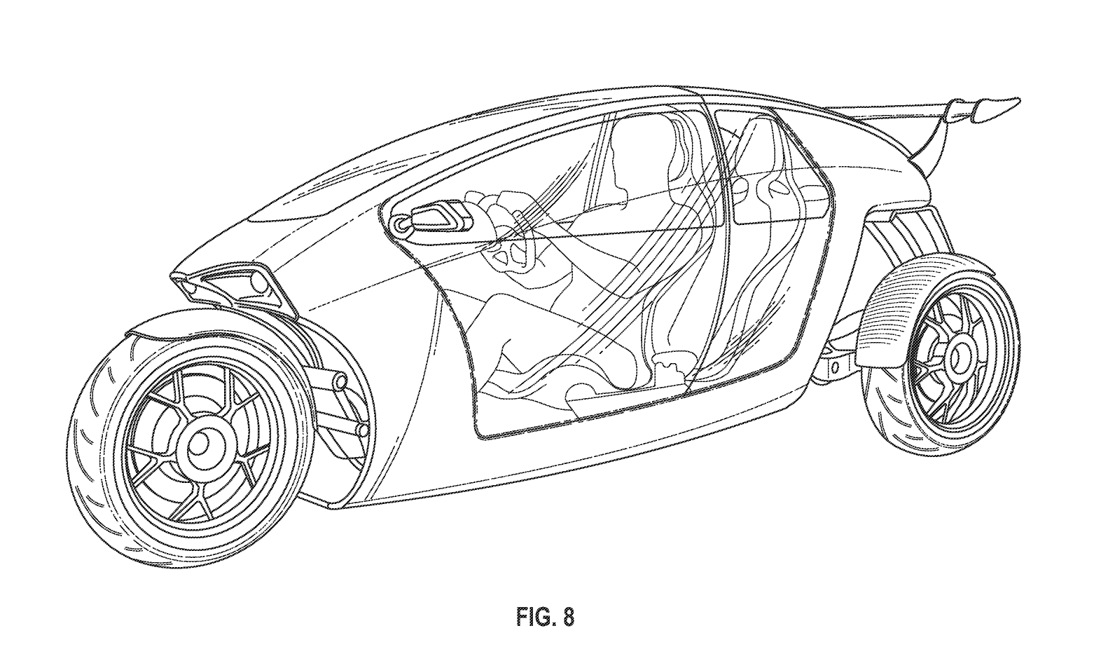

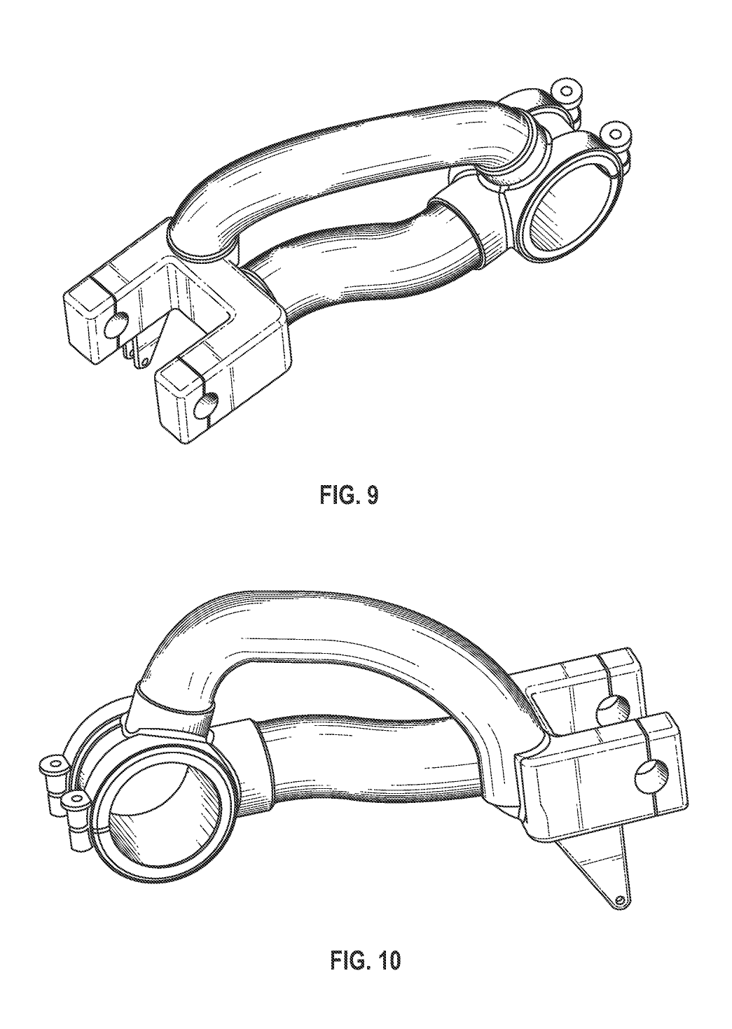

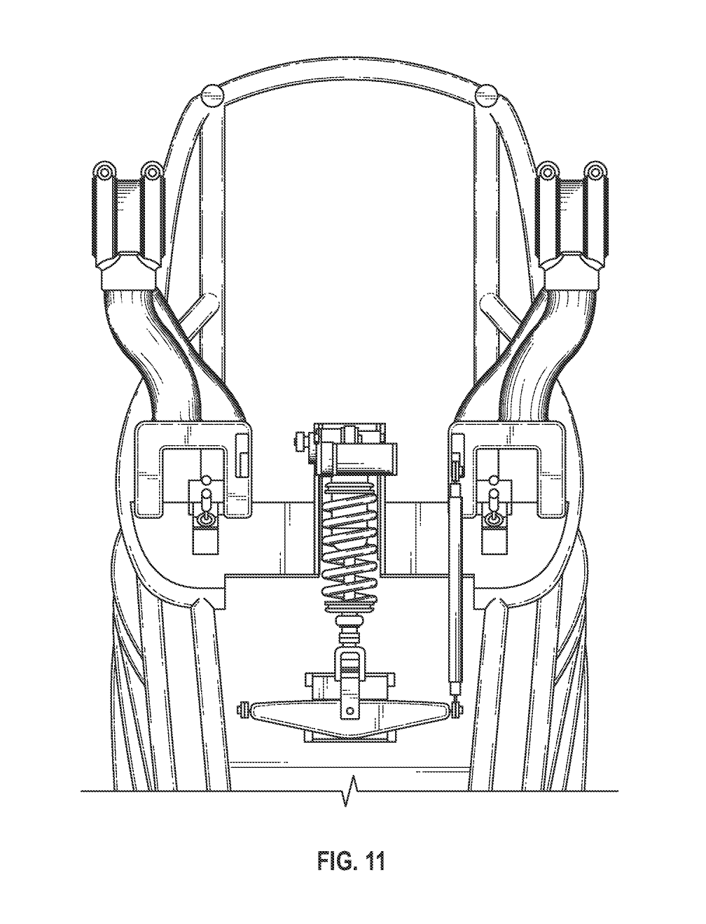

FIG. 5A, Illustrates a rear-side view of the passenger compartment structure in the present invention. FIG. 5B, Illustrates a forward-side view of the passenger compartment structure in the present invention. The passenger compartment structure may comprise of either metallic or composite materials. Metal may be mid steel, chromolly, or aluminum extrusions. Composite materials may be carbon fiber, high strength fiber-glass, or the like. The material that we use will not effect the impact requirements. Each metal being used first must he tested to meet the crash requirements.

FIG. 6A. Illustrates a top view of the rear swing arms. FIG. 6B. Illustrates a side view of the rear swing arms. The swing arm can be as simple as rod.

FIG. 7. Illustrates a bottom view of how the rear swing arms may be connected to the three-wheeled vehicle. The spring apparatus illustrated is the tilt and suspension mechanism that controls the rear wheels.

What is claimed is:

1. A three-wheeled vehicle comprising of;
A passenger compartment;
At least one swing arm; and
Wherein the rear wheels are attached to the passenger compartment via the swing arms.
